(19) United States
(12) Patent Application Publication
(10) Pub. No.: US 2016/0381739 A1
(43) Pub. Date: Dec. 29, 2016

(54) Induction Furnace with Improved Circulation of Molten Metal

(71) Applicant: Daniel S. Smalley, Sebastian, FL (US)

(72) Inventor: Daniel S. Smalley, Sebastian, FL (US)

(21) Appl. No.: 14/748,040

(22) Filed: Jun. 23, 2015

(51) Int. Cl. H05B 6/34; H05B 6/20

(52) U.S. Cl. CPC H05B 6/34; H05B 6/20

(57) ABSTRACT

Disclosed is an induction furnace with improved circulation of the molten metal. The increased circulation and is achieved by positioning the greatest magnetic field strength in a location above one or more of the channel vertical legs. This arrangement is achieved by (a) using an angled core to position the field over the upper channel opening or (b) by positioning the upper channel leg opening by lowering the channel opening to within the magnetic core window.

### TECHNICAL FIELD

This disclosure relates to an induction furnace. More particularly, the disclosure relates to a channel induction furnace wherein the induction core is positioned to promote increased circulation of the molten metal.

### BACKGROUND OF THE INVENTION

Induction furnaces are known in the art. They are widely used in the casting industry to melt metals such as iron, steel, cooper, aluminum, precious metals, as well as other metals and metal alloys. A variety of induction furnaces exist, such as vertical channel induction furnaces, horizontal channel furnaces, and barrel furnaces. All of these furnaces use an electric current to inductively heat the metal contained within the furnace.

FIG. 1 is a perspective, partial sectional view, of a vertical channel induction furnace. The furnace includes an upper body that includes a refractory wall lining. As is known, the refractory material is design to maintain its strength at very high temperatures. Oxides of aluminum, silicon and magnesium can be used as a refractory material. The lower extent of the furnace includes a channel through which the molten metal is passed. The lower extent also includes an inductor assembly that includes a magnetic steel core and a power coil. As current is passed through the power coil, a corresponding magnetic field is generated about the inductor assembly. This magnetic field inductively heats the molten metal within the channel.

However, the Lorenz forces generated by the power coil can create problems within the channel at high power levels. The generated forces can be too strong and can pinch off the channel diameter by compressing the channel metal against the outer refractory wall. This abruptly changes the electrical characteristics of the channel loop. This, in turn, can result in power supply fluctuations that may trip the power offline.

Various efforts have been made through the years to promote adequate stirring or circulation of molten metal within a furnace or bath. For example, U.S. Pat. No. 5,948,1382 to Issidorov discloses a method for stirring molten metal using electromagnetic fields. The method employs a metallurgical vessel that holds a volume of molten metal. A source of magnetic flux promotes the directional movement of molten metal along the bottom of a refractory lining.

WO 2014/1553572 to Pavlov discloses an apparatus for moving molten metal. The apparatus includes an inductor with at least two pairs of electromagnetic pole pairs that together generate a moving electromagnetic field component. A second magnetic field component is generated between the two poles in one or more electromagnetic pole pairs. The second field generates one or more eddy currents in the molten metal. The eddy currents are generally parallel to the surface of the molten metal and thus have a greater magnitude and extent than the eddy currents perpendicular to the surface. These eddy currents provide useful additional movement to the molten metal. This is particularly used for stirring purposes particularly when the depth of the molten metal is small.

U.S. Pat. No. 8,343,516 to Morgenstern discloses a device for regulating the flow rate and for slowing down nonferromagnetic, electrically conductive liquids. The device includes one stationary magnetic field with a constant polarity. It also includes at least one stationary magnetic alternating field and a multi-polled magnetic travelling field. In this way, magnetic field lines transversally penetrate the melt flow across the entire section. This serves to regulate the flow rate of the melt.

Each of the foregoing references achieves its own unique objective. However, none of the background art is directed to orienting an induction core for the purpose of promoting the circulation of molten metal within an induction furnace.

### SUMMARY OF THE INVENTION

This disclosure relates to an induction furnace that promotes the circulation of molten metal within the furnace.

One of the advantages of the present disclosure is achieved by angling an inductor core within the furnace inductor unit.

A further advantage is realized by concentrating the Lorentz forces generated by an inductor coil in a direction that promotes circulation of the molten metal.

Still yet another advantage is accomplished by configuring an inductor to take advantage of the Bernoulli principle by increasing the rate at which molten metal is circulated within an induction furnace.

Another important advantage of the present disclosure is achieved via the discovery that the Lorentz forces generated by an induction coil are concentrated within the bounded window area defined by the magnetic core.

The present inventors have capitalized on this discovery by angling this bounded area relative to the horizontal.

Yet a further advantage of the present disclosure is realized by providing a dual loop channel inductor with a core that is angled relative to the horizontal.

A further advantage of the present disclosure is realized by forming the inductor channel into a shape that promotes movement of the molten metal.

Various embodiments of the invention may have none, some, or all of these advantages. Other technical advantages of the present invention will be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a perspective view of a conventional vertical inductor furnace.

FIG. 2 is an elevational, cross-sectional view of a conventional single loop inductor assembly.

FIG. 3 is a side elevational view of the C-shaped core employed by the present inductor assembly.

FIG. 3a is an elevational, cross-sectional view of the C-shaped core taken along Line 3A-3A of FIG. 3.

FIG. 4 is an elevational, cross-sectional view of an inductor assembly with an angled inductor in accordance with the present disclosure.

FIG. 5 is a perspective, cross-sectional view of an inductor assembly similar to that of FIG. 4.

FIG. 6 is an elevational, cross-sectional view of a dual loop inductor assembly constructed in accordance with the present disclosure.

FIG. 7 is an elevational, cross-sectional view of an alternative dual loop inductor assembly constructed in accordance with the present disclosure.

FIG. 8 is an elevational, cross-sectional view of an alternative embodiment employing a pear-shaped inductor channel.

FIG. 9 is an elevational, cross-sectional view of an alternative embodiment employing a pair of pear-shaped inductor channels.

FIG. 10 is an elevational, cross-sectional view of an alternative embodiment employing a pair of pear-shaped inductor channels and a horizontally oriented core.

Similar reference numerals refer to similar parts throughout the several views of the drawings.

### DETAILED DESCRIPTION OF THE DRAWINGS

The present disclosure relates to an induction furnace with improved circulation of the molten metal. The increased circulation is achieved by positioning the induction core at an angle with respect to the horizontal. By positioning the inductor core in this manner, the associated Lorentz forces can be concentrated to promote increased circulation of the molten metal. The various components of the present invention, and the manner in which they interrelate, will be described in greater detail hereinafter.

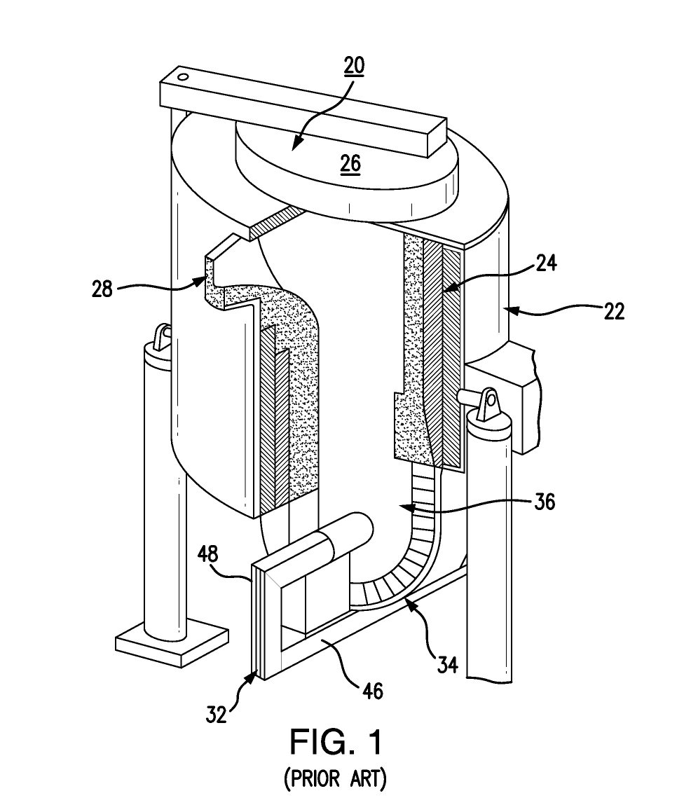

FIG. 1 illustrates a conventional induction furnace 20 designed to inductively heat a charge of metal. This conventional furnace 20 includes a housing 22 for storing the charge of metal. Furnace 20 is lined with a refractory material 24. Refractory material 24, as is known in the art, can preferably withstand the increased temperatures associated with molten metals. A cover 26 and a pour spout 28 are positioned at the upper extent of housing 22 for accessing the stored molten metal. Furnace 20 may be supported on hinges to permit it to be tipped. An induction assembly 32 is positioned at the lower end of furnace 20. Induction assembly 32 includes a C-shaped core 46. Electrical current passing through a copper coil on the C-shaped core 46 sets up an electromagnetic field that inductively heats the metal.

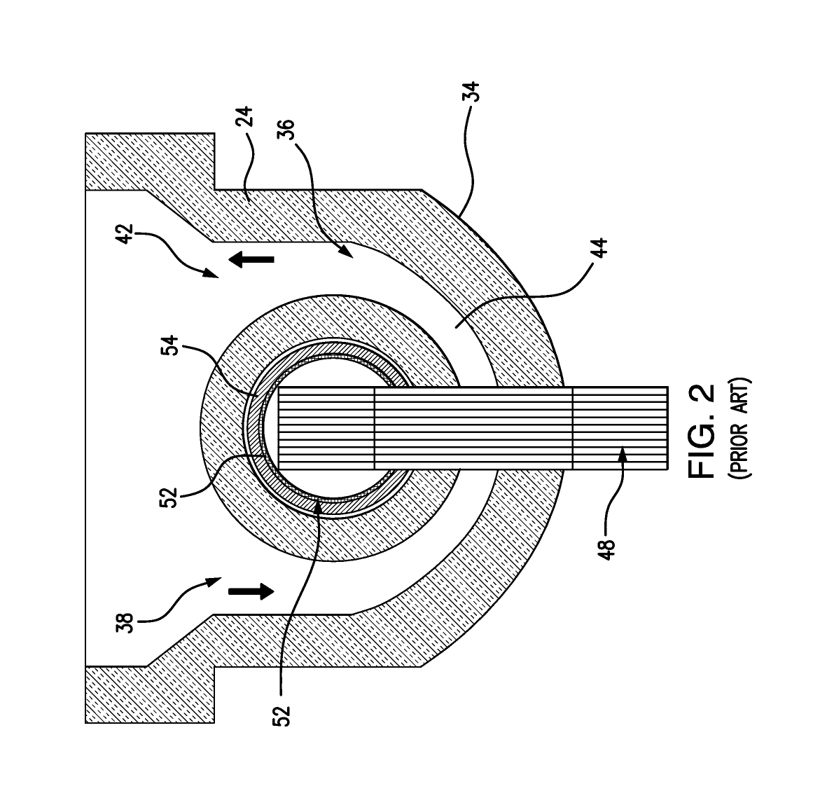

FIG. 2 is a cross-sectional view of the induction assembly 32 depicted in FIG. 1. Induction assembly 32 is positioned within a lower case 34 of housing 20. Lower case 34 includes a refractory material 24 that defines a channel 36 for the molten metal path through the core window area and around the power coil. As is known in the art, the channel path 36 is formed by secondary loop formers that are held in place as the refractory material is rammed around them. The channel 36 forms the electrically conductive loop wherein the metal is heated. Channel path 36 is created by thereafter removing the loop formers by melting. This results is a refractory lining on the inner surface of the housing as well as an interior bushing channel refractory. Regardless of how it is formed, the electrically conductive path 36 within lower case 34 generally includes an inlet and an outlet (38 and 42, respectively) with a curved intermediate extent 44. As illustrated in FIGS. 1 and 2, the end of C-shaped core 46 is closed by a butt end 48. This closed core path 46 creates a closed flow path for the passage of magnetic flux flow. The refractory channel path 36 creates a closed flow path for the passage of electrical current flow.

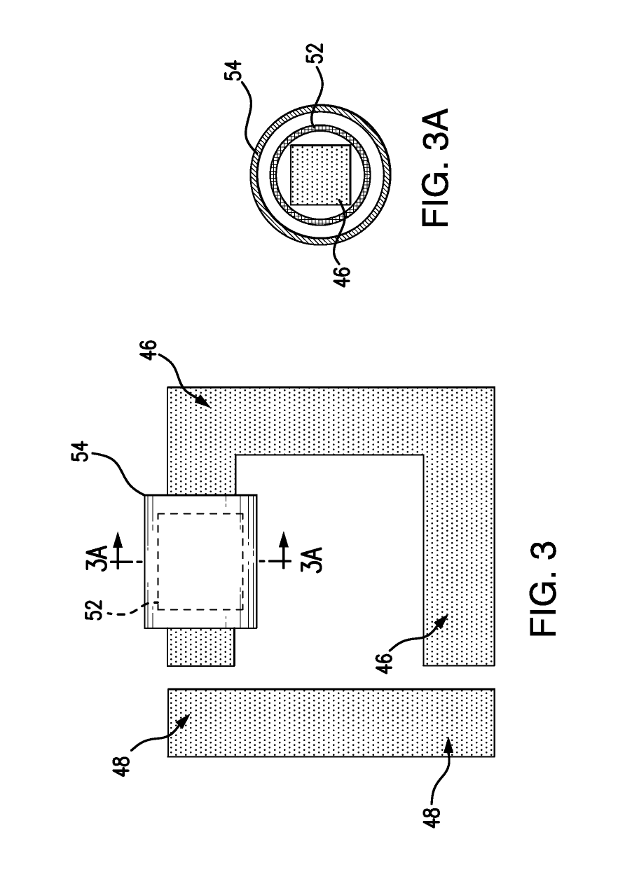

A C-shaped core 46 is illustrated in FIGS. 3 and 3a. As illustrated, core 46 takes a C-shape with two parallel legs. A power coil 52 and an outer bushing 54 are positioned about one leg of C-shaped core 46. C-shaped core 46 is closed by securing butt end 48 between the two legs of the core 46. Molten metal within the channel path 36 (FIG. 2) is heated by electric current flow caused by magnetic fields generated by power coil 52. As illustrated in FIG. 2, C-shaped core 46 and butt end 48 are orientated vertically both with respect to the ground and the surrounding furnace 20. It has been discovered that this arrangement is problematic as the forces generated by core 46 can be too strong and can pinch off the channel diameter at its lowermost extent. This pinching effect is caused by Lorentz forces compressing the channel metal against the outer refractory wall.

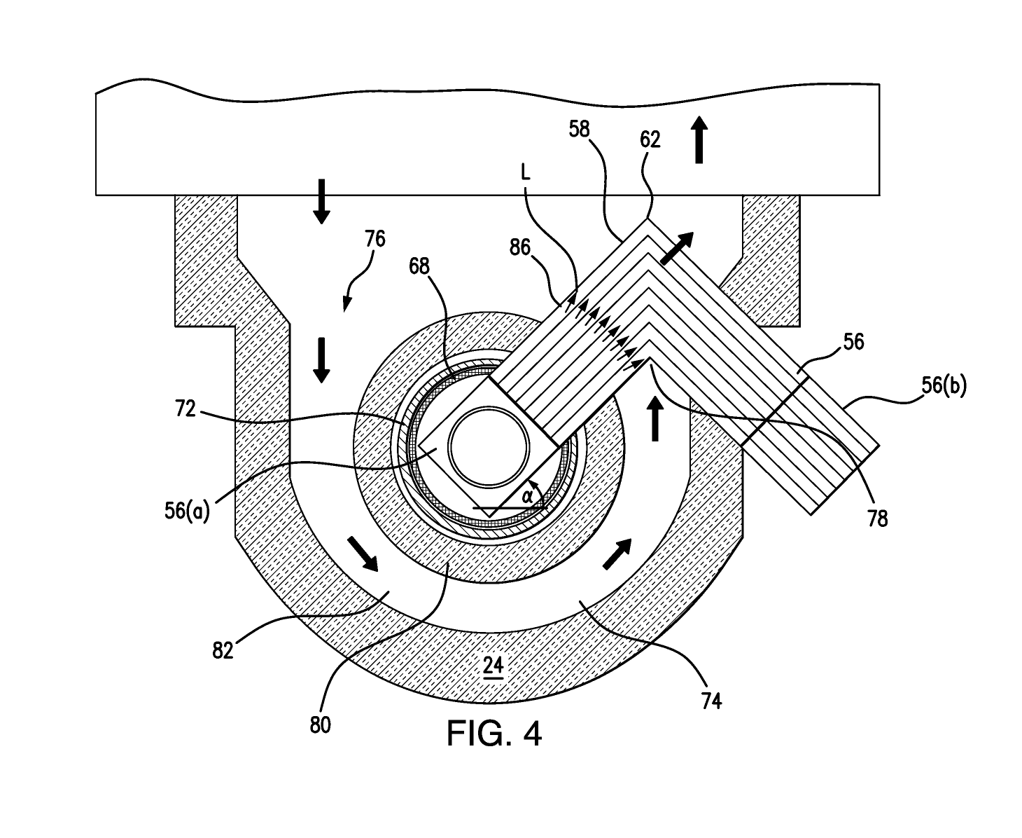

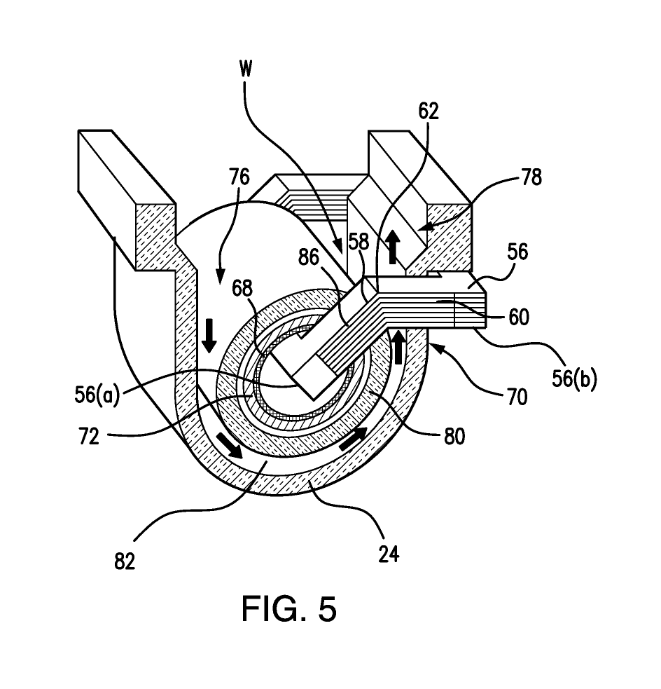

The induction assembly 70 of the present disclosure is described next in association with FIG. 4. The induction assembly of the disclosure includes a magnetic core 56. Core 56 is bent along its length and angled with respect to the ground. Magnetic core 56 is also preferably laminated, being made up of a series of flat strips of steel that are electrically insulated from one another but are bolted, or similarly secured, together. In a manner similar to core 46, core 56 is formed into a generally a “C” shaped configuration with a first leg 56(a) and a second leg 56(b) that are generally parallel to one another. This is most clearly illustrated by the perspective view of FIG. 5. FIGS. 4 and 5 illustrate the same configuration except for the angle of the bent core 56. FIG. 5 further illustrates how first leg 56(a) extends through a central opening the bushing channel refractory 80. A butt end 58 is bolted between legs 56(a) and 56(b) to form core 56 into a closed loop. The loop forms a continuous path for the magnetic flux flow. The closed loop also defines an interior area referred to as the core window “W”.

Core 56 is bent by bending both the butt end 58 and the opposite side of core 56 (not shown). In the depicted embodiment, the bend is approximately a 90° angle in FIG. 4. In the embodiment of FIG. 5, the bend is approximately a 135°. In all other respects, the assemblies of FIGS. 4 and FIG. 5 are the same. Furthermore, the bend is formed at the midpoint of both butt end 58 and the opposite side of the core. Although FIG. 4 depicts a bent core 56, the advantages of the present disclosure can still be realized without a bend or with a bend of a different angle. The position of the bend along the butt end 58 can also be changed. It is also within the scope of the present invention to angle legs 56(a) and 56(b) and thereby eliminate the need for forming bend in butt end 58 and the opposing side of the core. Namely, the bend can be optionally formed along the length or width of core 56 in order to accomplish the objective of preventing a distal end of core 56 from protruding into the molten bath. Thus, bend depicted in FIGS. 4 and 5 accomplishes purpose of preventing the second, and distal, leg 56(b) from protruding into the molten bath of furnace 20. Instead leg 56(b) extends outwardly from the lower extent of housing 34. Any number of other shapes and configurations can be utilized to achieve this same objective.

With continuing reference to FIG. 4, power coil 68 and bushing 72 are illustrated secured about the first leg 56(a) of the core. Power coil 68 and bushing 72 are likewise positioned within the central opening of bushing refractory 80. Power coil 68 can be formed by a conductive material that is wound into a tight coil. Coil 68 can take a variety of shapes and sizes and can include, for example, between 10-30 turns of a copper wire. A bushing 72 is then positioned over coil 68. As illustrated, bushing 72 can be formed such that it directly contacts or is in close proximity to the internal surface of bushing refractory 80. Both the coil and the bushing (68 and 72) can optionally be water cooled.

As illustrated, the power coil and bushing (68 and 72) are positioned within the lower case adjacent the arcuate flow path 74. Flow path 74 includes an inlet 76, and outlet 78, and an arcuate extent there between 82. Current flowing through the power coil 68 sets up an electromagnetic field within core 56. This electromagnetic field induces an electrical current in the molten metal loop formed by the channel and the above metal pool. The electrical current, in turn, generates Lorenz forces that extend perpendicularly from the induced electrical current flow path. The Lorenz forces are, therefore, perpendicular to the path 74 of the molten metal electrical current flow. Channel path and the above metal pool can be viewed as an electrically conductive loop 74 secondary winding of a transformer and the power coil the primary winding of a transformer. The induced voltage within channel 74 functions in pushing electron flow through the channel from the inlet 76 to the outlet 78 and then though the above metal pool.

In accordance with the present invention, first leg 56(a) of core 56 is oriented such that it is positioned at an angle “α” relative to the horizontal (FIG. 4). In a preferred but non-limiting embodiment, angle α is approximately 45 degrees. The core is further oriented such that it extends towards the outlet 78 of the channel path. It has been discovered that the electromagnetic Lorenz forces generated by the core 56 are the greatest within the area bounded by the core 56 (i.e. the core window W). This discovery can be taken advantage of by positioning core window W over outlet 78. More particularly, window W is oriented such that it extends over outlet 78. In this manner the generated Lorenz forces urge the molten bath in a direction toward the outlet. Additionally, the Lorenz forces within window W accelerate the molten metal to create a low pressure area in accordance with the Bernoulli effect. This further improves the overall circulation. Although in the particular embodiment illustrated in FIG. 4 angle “α” is approximately 45 degrees, other angles can readily be used to achieve the objects of the present disclosure. In particular, angle “α” should be chosen to ensure that window W is positioned over the outlet of the flow channel. None of this is found in the prior devices, such as the vertically oriented core 48 of FIG. 2. Such vertically oriented cores direct associated Lorenz forces against the wall of the adjacent flow path 44, thereby pinching the molten metal. Nor is the molten metal otherwise accelerated.

As current passes through power coil 68, a magnetic field is generated within coil 68. This, in turn, generates an electrical current within flow path 74 that heats the molten metal contained therein. The current within power coil 68 is chosen to induce an inductive current that is sufficient to completely melt, or hold at a particular temperature, the metal or alloy being heated. As noted, the electrical current generated within the flow path also generates Lorenz forces “L.” The Lorentz forces are a combination of the forces generated by the magnetic field within core 56 and the corresponding current generated within channel 74. Lorenz forces are governed by the equation L=B×I×L, wherein B is the magnetic field density, I is the amount of current, and L is the length of the conductor under the iron core. Thus, increasing the current within the channel increases the Lorenz forces generated.

As illustrated by the arrows “L” in FIG. 4, the Lorenz forces extend outwardly at a 90 degree angle relative to the current flow and have the greatest magnitude in the area of the core window. Thus, the shape of channel 74 is important because it establishes the direction of: molten metal flow; the direction of the current within the metal flow; and the corresponding Lorenz forces (90 degrees orthogonal to the flow). It has also been discovered that the Lorenz forces “L” are mostly concentrated within the bound window area W of the magnetic core. Approximately 85 to 95 percent of all the Lorenz forces are concentrated in this area. This concentration of Lorenz forces was not previously appreciated. By orienting the core in the direction of the induction channel outlet 78, these forces can be used to promote the flow of the molten metal out of the upper channel outlet 78 and into the bath and then back into upper channel 76. This is the result of both the vectored Lorenz forces and the corresponding low pressure area in the area of the core window W. Alternatively, if the core is positioned either horizontally or vertically, the resulting Lorenz forces tend to squeeze the molten metal as the electrical current is passing through the channel. This does not cause metal to flow through the channel. The present channel metal flow is accomplished by thermo siphoning. Namely, as the channel's heated metal rises the bath's cooler metal sinks into the channel.

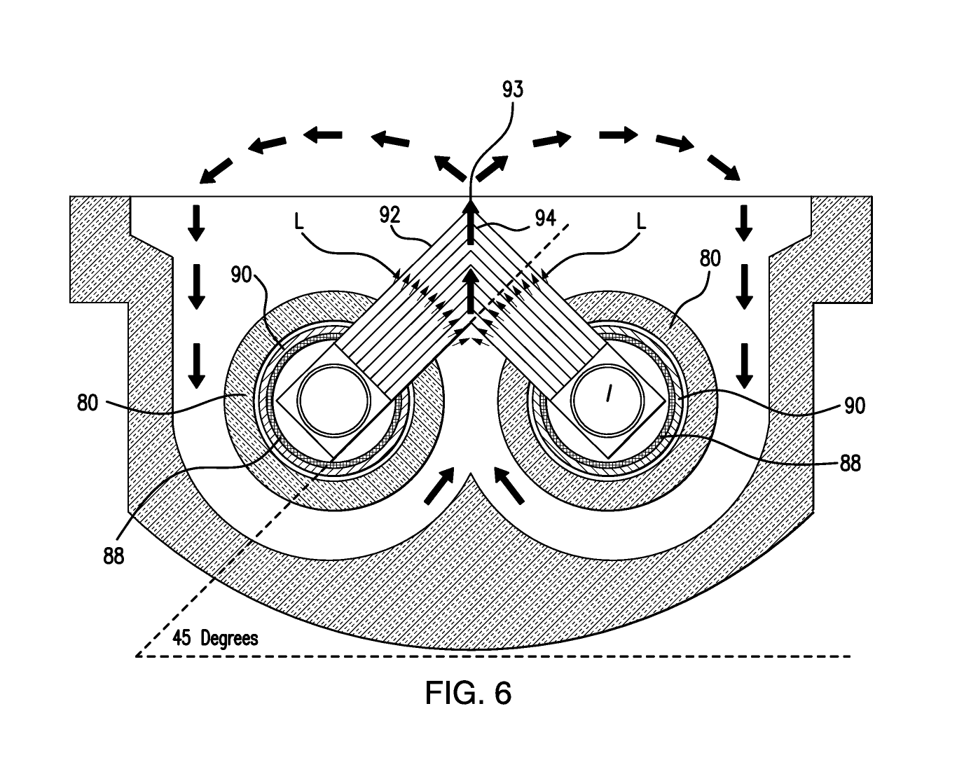

FIG. 6 is a further embodiment of the present disclosure that employs two side-by-side inductor assemblies and two bushing channel refractories 80. In this embodiment, a single bent core 92 is employed. Core 92 includes two legs, with each leg positioned within one of the channel refractories 80. Each leg of core 92 further includes a power coil 88 and an outer bushing 90 that are positioned within the corresponding bushing channel refractory 80. Core 92 is preferably bent at a right angle at midpoint 93. This bend is preferably formed in both butt end and opposite end of core 92. As illustrated, the midpoint 93 of core 92 is positioned between the inductor assemblies. Passing current through both the power coils 88 generates Lorenz forces noted by the smaller arrows “L”. These Lorenz forces are generated in manner described above. However, the orientation of bent core 92 results in two force components that complement one another and drive the molten bath upwardly in the direction 94. Namely, the position of the core 92 creates a low pressure area between the two refractory cores 80. This drives the flow upwardly between the two bushing channel refractories 80 and downwardly at the outer channel entrances. By adjusting the degree of bend, the resulting upward force can be adjusted.

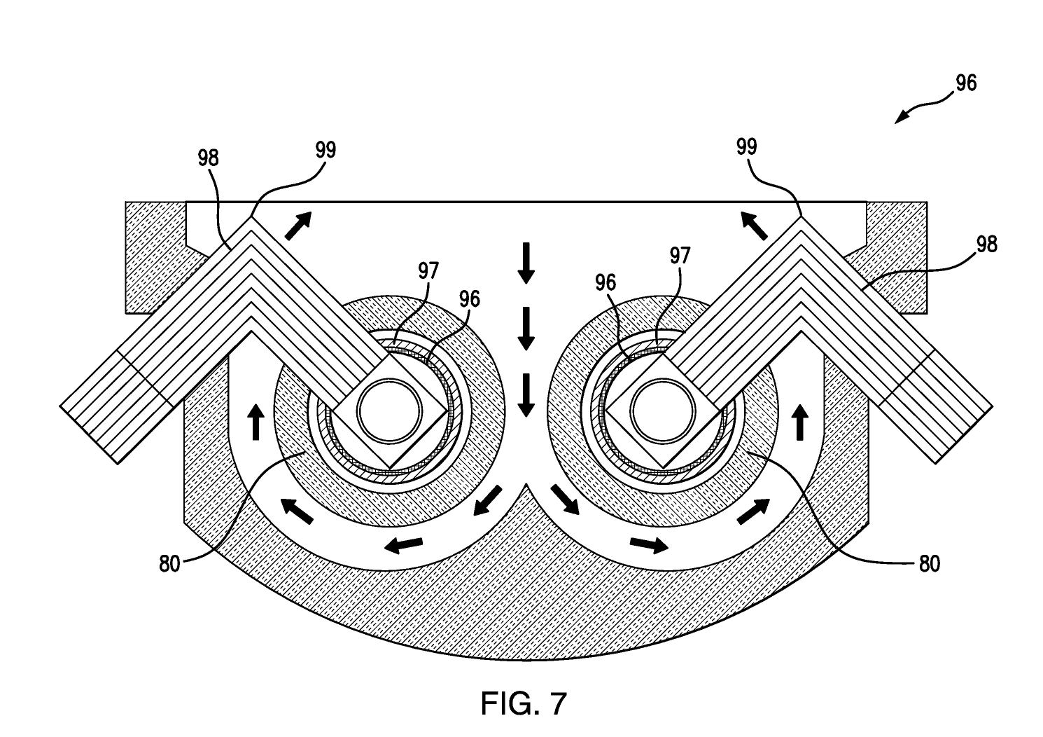

FIG. 7 illustrates yet another embodiment that is similar in most respects to the embodiment of FIG. 6. However, instead of a single bent core 92, two separate bent cores 99 are utilized. Furthermore, each core 99 is oriented in a manner similar to FIG. 4. Each core includes a leg with a power coil 96 and an outer bushing 97. The power coil 96 and bushing 97 are each positioned within a corresponding refractory 80. Each core 98 is bent at a location 99 that is adjacent the outer edge of the casing. This promotes movement of the bath downwardly between the bushing channel refractories 80 and upwardly adjacent the outer channel legs.

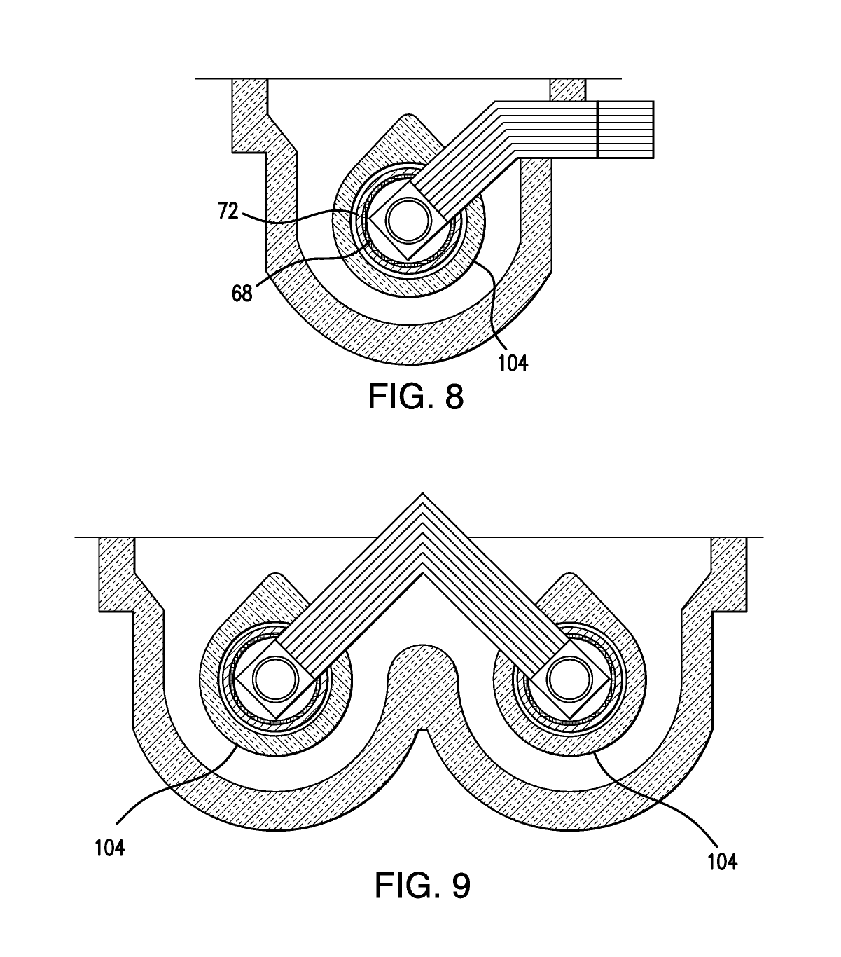

FIGS. and 9 illustrate further inductor assemblies. In these embodiments the bushing channel refractory 104 is pear-shaped or tear drop shaped 104. FIG. 8 illustrates a flow channel for a single loop inductor. FIG. 9 illustrates the flow channel for a twin loop inductor. The pear-shape results in the upper sides of the flow channel being angled at approximately 45°. Importantly, this 45° is adjacent to the flow channel outlet. The geometry of the refractory 104 and its relationship to the outlet promotes a more concentrated upward flow.

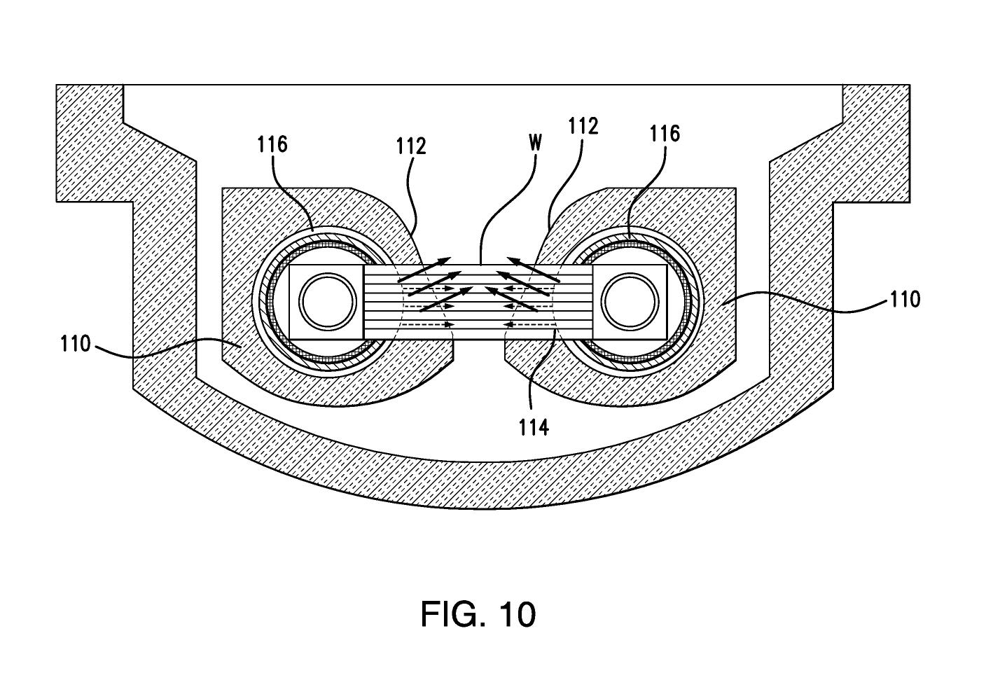

FIG. 10 illustrates a further alternative embodiment of the inductor assembly. This embodiment employs two side by side bushing channel refractories 110. Each of these channel refractories 110 has an interior edge 112 that is angled with respect to the vertical. The inductor assembly also includes a horizontally oriented core 114. Each opposing end of core 114 includes a power coil 116 that is positioned within the interior area of the corresponding channel refractory 110. Core 114 includes a core window W that is oriented over the passage between the opposing channel refractories 110. Molten metal flowing between the channel refractories 110 is acted upon by Lorenz forces generated by the power coils 116. These forces are perpendicular to the flow of the molten metal in the channel. Interior edges 112, therefore, vector the Lorenz forces to urge the molten metal upwardly as noted by the arrows in FIG. 10. Thus, although the core 114 is not angled, a lower pressure area is nonetheless created within the window area W by virtue of the configuration of the channel refractories 110. The greatest forces will be generated within the window area W. Surfaces 112 assure that these forces are not directly opposite to one another. Rather, the Lorenz forces are directed at an angle to generate a vertical component.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. An induction furnace with an angled inductor assembly for improved circulation of the molten metal, the induction furnace comprising:
a body that is lined with a refractory material and which houses a molten metal bath, the body including an upper extent with a cover and a pour spout and a lower extent;
a lower case secured to the lower extent of the body, the lower case including a refractory lining defining an arcuate flow path, the flow path including an inlet and an outlet for allowing for the passage of the molten metal to and from the molten metal bath;
a laminated magnetic core assembly, the core including a C-section with first and second legs, the core including a butt end that is secured between the first and second legs of the C-section to define a bounded window area, the core further defined by first and second extents that are angled at approximately 90° with respect to each other;
a power coil and bushing wrapped around the first leg of the core and positioned within the lower case adjacent the arcuate flow path, the core assembly being orientated such that the first extent is positioned at approximately a 45° angle relative to the horizontal and such that the first extent is oriented toward the outlet;
a voltage source for generating a current within the power coil, the current generating a magnetic field that induces electrical current flow and that heats the molten metal within the arcuate flow path, the current generating Lorenz forces that are 90 degrees from the electrical current flow, with the Lorenz forces being concentrated along the first extent of the core;
whereby the circulation of the molten metal is improved by concentrated Lorenz forces facilitating movement of the molten metal through the outlet.

2. An induction furnace with an angled inductor assembly for improved circulation of the molten metal, the induction assembly comprising:
a lower case defining a flow path, the flow path including an inlet and an outlet for allowing for the passage of the molten metal;
a core assembly defining a bounded window area;
a power coil wound around the core and positioned within the lower case adjacent the arcuate flow path, the core assembly being orientated at an angle relative to the horizontal.

3. The induction furnace as described in claim 2 further comprising a current source for generating a current within the power coil, the current generating a magnetic field that inductively heats molten metal within the flow path.

4. The induction furnace as described in claim 2 wherein the flow path is arcuate.

5. The induction furnace as described in claim 2 wherein an induced current is flowing through the channel path, the current generating Lorenz forces that radiate 90 degrees from an electrical current flow path, with the Lorenz forces being concentrated within the core window area.

6. The induction furnace as described in claim 5 whereby the circulation of the molten metal is improved by concentrated Lorenz forces facilitating movement of the molten metal through the outlet.

7. The induction furnace as described in claim 2 wherein the core is further defined by first and second extents that are angled at approximately 90° with respect to each other.

8. The induction furnace as described in claim 2 wherein the furnace is a twin loop inductor and a core is included for each of the loops.

9. The induction furnace as described in claim 2 wherein the electrical current flow path is pear-shaped.

10. An induction furnace for improved circulation of the molten metal, the induction assembly comprising:
a lower case defining a flow path, the flow path including an inlet and an outlet for allowing for the passage of the molten metal;
a core assembly for inductively heating the molten metal, the core assembly being oriented to create a low pressure area adjacent the outlet.

11. The induction furnace as described in claim 10 wherein the core assembly is orientated at an angle relative to the horizontal.

12. The induction furnace as described in claim 10 wherein the core is further defined by first and second extents that are angled at approximately 90° with respect to each other.
